(19) United States
(12) Patent Application Publication
(10) Pub. No.: US 2008/0118048 A1
(43) Pub. Date: May 22, 2008

(54) DIRECTORY SERVICE FOR LOCATING STALE ACQUAINTANCES

(76) Inventor: John Lowe, Bethesda, MD (US)

Correspondence Address: HARRITY SNYDER, LLP, 11350 Random Hills Road, SUITE 600, FAIRFAX, VA, 22030, US

(21) Appl. No.: 11/561,007

(22) Filed: Nov. 17, 2006

(51) Int. Cl. H04M 3/42

(52) U.S. Cl. 379/218.01

(57) ABSTRACT

A directory service encourages subscribers to store old or out-of-date contact information. When someone wishes to get in touch with another person with whom they no longer have current or complete contact information, they may query the online directory service with one or more out-of-date or incomplete contact fields (e.g., an old phone number and a name).

### BACKGROUND

A. Field of the Invention

Implementations described herein relate generally to directories of people and, more particularly, to a directory service for contacting persons who have subscribed to the service (“subscribers”) and who are being searched for by someone (“a searcher”), who may or may not be an acquaintance of the subscriber being sought.

B. Description of Related Art

It is human nature to make acquaintances. As time moves on, one, however, may lose track of acquaintances. For example, contact information or other information about the acquaintances, such as telephone number, email addresses, or postal address, may become out of date.

Reestablishing contact with an old acquaintance can be difficult. Establishing contact with someone who is not an acquaintance but whose historical information a searcher has is even more difficult. Searching by name using conventional name directories, such as printed or online phone directories, may result in a long list of possible contact phone numbers. Only one or possibly none of such a list may match the searched-for person. Calling each of the contacts on the list can be a daunting task.

Accordingly, it would be desirable to be able to more easily reestablish contact with or otherwise find a person being sought.

### SUMMARY

One aspect is directed to a method that may include storing directory information that includes out-of-date contact data obtained from subscribers; receiving a request from someone (“searcher”) to contact a possible subscriber; comparing, in response to the request, information associated with the request to the directory information; and, when the comparing indicates that the directory information includes the subscriber, transmitting a message to the subscriber informing the subscriber of the request to contact the subscriber.

Another aspect is directed to a method that may include receiving out-of-date contact information about an acquaintance; matching the out-of-date contact information to a database that includes a plurality of fields configured to store, for each of a plurality of subscribers, out-of-date contact data and current contact data; and transmitting a message to one or more of the plurality of subscribers based on the matching of the out-of-date contact information about the acquaintance to the database.

In another aspect, a system may include a storage mechanism to store directory information defined by a plurality of fields configured to store out-of-date contact data obtained from subscribers; a processor; and a memory to store instructions. The instructions, when executed by the processor, may cause the processor to receive out-of-date contact information about one of the subscribers from a searcher interested in making contact with the subscriber; may match the received out-of-date contact information to the directory information stored in the database; and may transmit a message to one or more of the subscribers when the received out-of-date contact information matches the directory information stored in the storage mechanism.

### BRIEF DESCRIPTION OF THE DRAWINGS

The accompanying drawings, which are incorporated in and constitute a part of this specification, illustrate embodiments of the invention and, together with the description, explain the invention. In the drawings,

FIG. 1 is an exemplary diagram of a network in which implementations described herein may be implemented;

FIG. 2 is a diagram of an exemplary client or server shown in FIG. 1;

FIG. 3 is a diagram illustrating an exemplary interface that a directory service component may provide to a newly registering subscriber or to a subscriber updating or adding to the subscriber's information;

FIG. 4 is a flow chart illustrating exemplary operations of the directory server component in locating searched-for persons for a searcher; and

FIG. 5 is a diagram illustrating an exemplary interface that the directory service component may provide to a searcher making a request to contact a person being sought.

### DETAILED DESCRIPTION

The following detailed description refers to the accompanying drawings. The detailed description does not limit the invention.

### Overview

Implementations consistent with principles described herein relate to an online directory service in which subscribers can store old or out-of-date contact information. When a searcher wishes to get in touch with another person with whom they no longer have current or complete contact information, they may query the online directory service with one or more out-of-date or incomplete contact fields (e.g., an old phone number and a name). When the online directory service includes a potential match, the service may automatically contact the matching subscriber to inform that matching subscriber that someone is trying to contact him/her. The matching subscriber may reply to the searcher if desired by the subscriber.

### Exemplary Network Overview

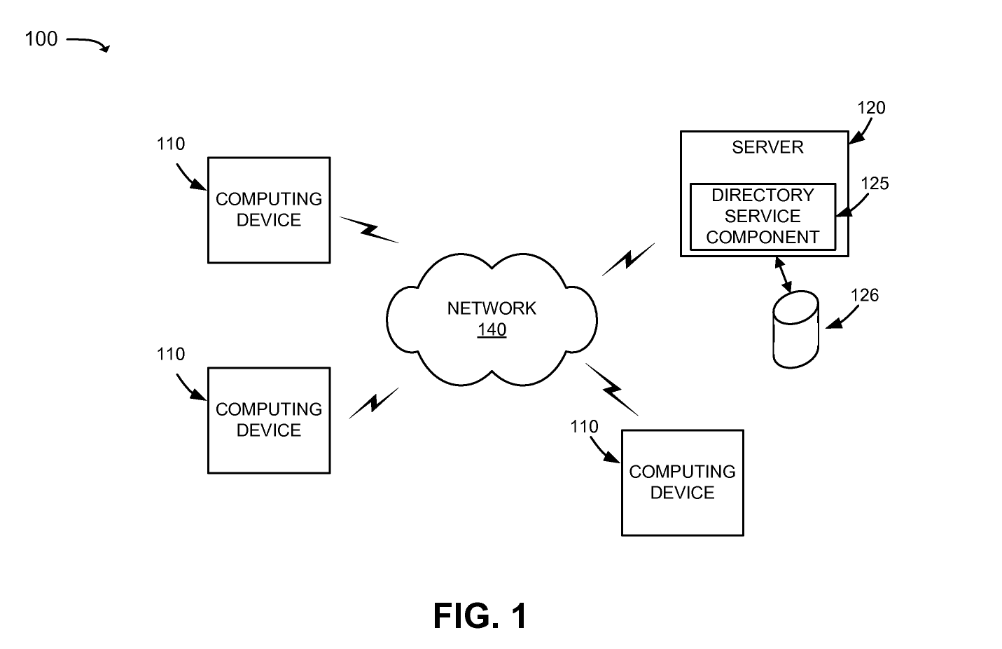

FIG. 1 is an exemplary diagram of a network 100 in which implementations described herein may be implemented. Network 100 may include multiple devices 110, such as computing devices, connected to a server 120 via a network 140. In operation, devices 110 may be used by a searcher or a subscriber to interact with directory service component 125 of server 120. Network 140 may include a local area network (LAN), a wide area network (WAN), a telephone network, such as the Public Switched Telephone Network (PSTN), an intranet, the Internet, or a combination of networks. Three devices 110 and one server 120 have been illustrated as connected to network 140 for simplicity. In practice, there may be more devices and/or servers. Also, in some instances, a device 110 may perform one or more functions of a server and a server may perform one or more functions of a device 110.

A device 110 may include, for example, a wireless telephone, a personal computer, a personal digital assistant (PDA), a lap top, or another type of computation or communication device, a thread or process running on one of these devices, and/or an object executable by one of these devices. Server 120 may include a server that processes, searches, and/or maintains documents and images in a manner consistent with principles of the invention. Devices 110 and server 120 may connect to network 140 via wired, wireless, or optical connections.

Devices 110 will typically be operated by users (e.g., searchers or subscribers) who, in the context of the present disclosure, will be either a person attempting to make contact with an old acquaintance (e.g., a prior friend, team mate, co-worker, associate, roommate, or loved one, etc., with whom the user has lost contact) or the person who is the old acquaintance. As used herein, the person attempting to make contact will be referred to as the “searcher” and the person being sought will be referred to as the “subscriber.”

Server 120 may include a directory service component 125 usable by searchers and subscribers. In general, directory service component 125 may implement the online directory service that is described in more detail below. Directory service component 125 may be coupled to a storage mechanism 126, which may be, for example, a database. Storage mechanism 126 may store the directory data used by directory service component 125.

### Exemplary Client/Server Architecture

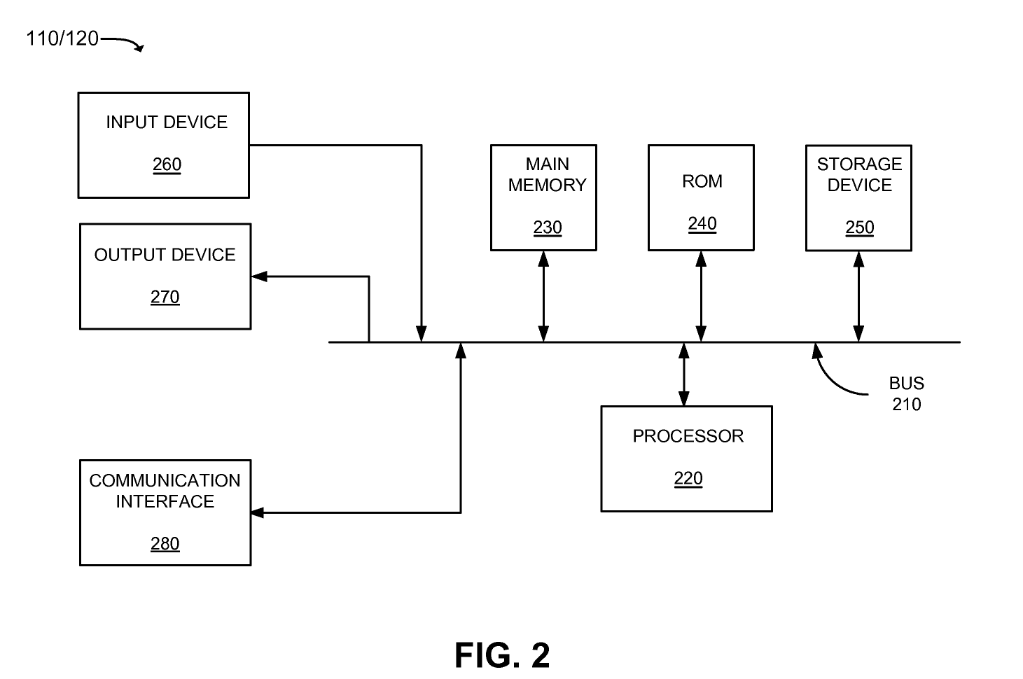

FIG. 2 is an diagram of an exemplary device 110 or server 120. Device/server 110/120 may include a bus 210, a processor 220, a main memory 230, a read only memory (ROM) 240, a storage device 250, an input device 260, an output device 270, and a communication interface 280. Bus 210 may include conductors that permit communication among the components of device/server 110/120.

Processor 220 may include conventional processors, microprocessors, or processing logic that interpret and execute instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device 260 may include one or more conventional mechanisms that permit a user to input information to device/server 110/120, such as a keyboard, a personal digital assistant (PDA), a mouse, a pen, voice recognition and/or biometric mechanisms, or other means, etc. Output device 270 may include one or more conventional mechanisms that output information to the subscriber or searcher, including, but not limited to, a display, a printer, a speaker, etc. Communication interface 280 may include any transceiver-like mechanism that enables device/server 110/120 to communicate with other devices and/or systems. For example, communication interface 280 may include mechanisms for communicating with another device or system via a network, such as network 140.

As mentioned, server 120 may implement directory service component 125. Directory service component 125 may be stored in a computer-readable medium, such as memory 230. A computer-readable medium may be defined as one or more physical or logical memory devices. Although shown as a single device in FIGS. 1 and 2, server 120 may also be implemented as multiple, potentially distributed, computing devices. Storage mechanism 126 may similarly be implemented across one or more storage or computing devices. In some implementations, storage mechanism 126 may be implemented as a relational database, a non-relational database, a file, or another type of data structure.

The software instructions defining directory service component 125 may be read into memory 230 from another computer-readable medium, such as data storage device 250, or from another device via communication interface 280 (e.g., storage mechanism 126). The software instructions contained in memory 230 may cause processor 220 to perform processes that will be described later. Alternatively, hardwired circuitry or other logic may be used in place of, or in combination with, software instructions to implement processes consistent with the invention. Thus, embodiments described are not limited to any specific combination of hardware circuitry and software.

### Directory Service Component

The operation of directory service component 125 will now be described in more detail.

A subscriber wishing to be included by directory service component 125 may initially register with directory service component 125. When registering, the subscriber may include old or stale (e.g., out-of-date) contact information. The subscriber may update or add to the subscriber's contact information as desired. Directory server component 125 may generally encourage subscribers to include stale contact information in the directory to make it possible for old acquaintances to contact one another.

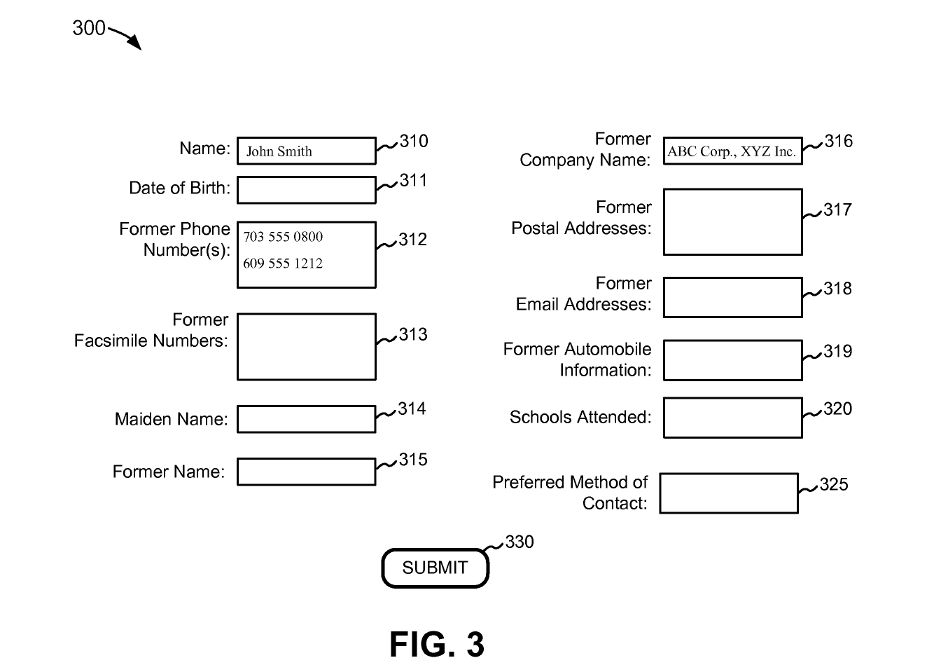

FIG. 3 is a diagram illustrating an exemplary interface 300 that directory service component 125 may provide to a newly registering subscriber or to a subscriber updating or adding to their information. In this example, assume that directory service component 125 is a web service and that interface 300 is a web page provided to the registering subscriber via, for example, a web browser window at one of clients 110.

Interface 300 may present a number of fields 310-320 to the subscriber. The fields may generally be designed to solicit contact information from subscribers and may tend to encourage subscribers to enter out-of-date contact information. As shown in FIG. 3, fields 310-320 may include, but are not limited to, a name field 310, a date of birth field 311, a phone number field 312, a facsimile number field 313, a maiden name field 314, a former name field 315, a company name field 316, a postal addresses field 317, an email address field 318, an automobile field 319, and a schools attended field 320. Fields 310-320 may be used to enter, respectively, subscriber name, date of birth, phone numbers, facsimile numbers, maiden name or other former name, company names, postal addresses, email addresses, information relating to former automobile(s) owned (e.g., make, model, color, year, etc.), schools attended, and other types of information. FIG. 3 shows exemplary fields. In other implementations, other information may be entered to aid a searcher in locating the subscriber, such as areas lived in, DNA or biometric identification information, etc.

Interface 300 may also include a preferred method of contact field 325. Through this field, the subscriber may enter current contact information, such as an email address or phone number, through which directory service component 125 may contact the subscriber.

Many of fields 310-320 may be optional fields. That is, the subscriber may fill out as many of fields 310-320 as desired. At least one field, however, may be required to be filled out so that directory service component 125 has a chance of matching a request to a subscriber.

In general, subscribers may fill out as many of fields 310-320 as they wish. In some of fields 310-320, subscribers may enter multiple values, and is encouraged to enter old or stale values. For example, a subscriber may enter a number of phone numbers in phone number field 312, all of which may be old phone numbers that may not even be currently valid for that subscriber. Similarly, the subscriber may enter a number of out-of-date postal addresses and a number of email addresses, company names, and facsimile numbers, which may also be be out-of-date.

When the subscriber has filled out as many fields in interface 300 as desired, the subscriber may select a “submit” button 330 to transmit the values to directory service component 125. If the subscriber is a newly registering subscriber, directory service component 125 may add a new subscriber profile to directory database 126 that is defined by the received values. If the subscriber is updating an account, directory service component 125 may update the appropriate values in storage mechanism 126. In this manner, storage mechanism 126 may be populated to include stale contact information for registering subscribers.

It can be appreciated that the particular layout and choice of fields for interface 300 is purely exemplary. For example, instead of presenting the subscriber with multiple different fields (e.g., text boxes) to fill in, directory service component 125 may present a single “freeform” text box in which the subscriber may enter as much information as desired.

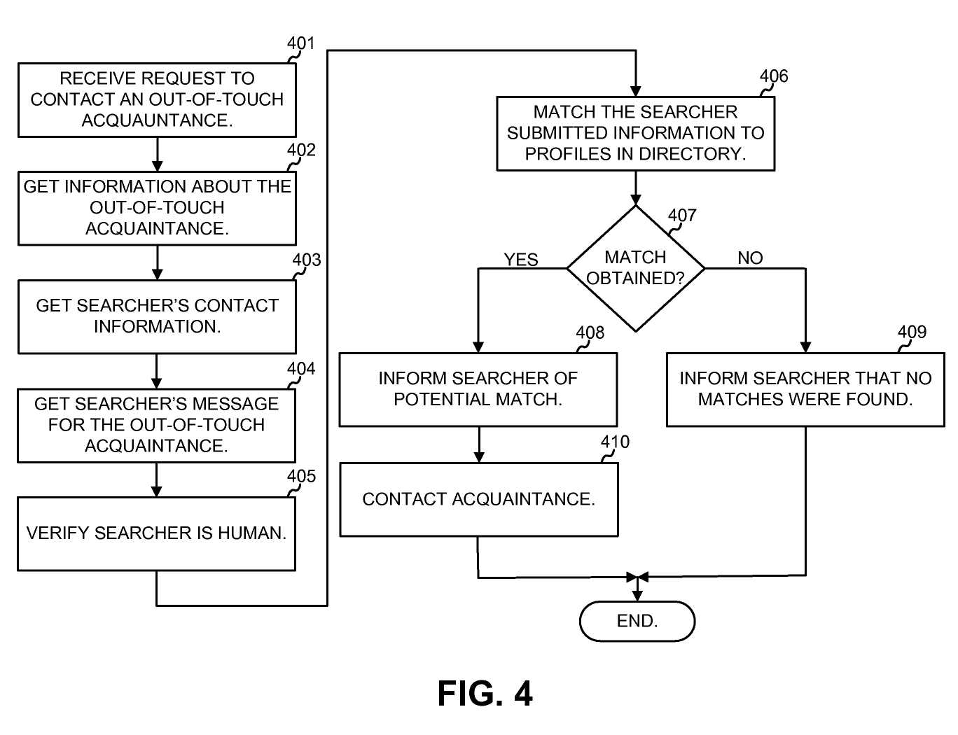

As previously mentioned, directory service component 125 may allow people to renew contact with out-of-touch acquaintances. FIG. 4 is a flow chart illustrating exemplary operations of directory server component 125 in locating out-of-touch subscribers (also called stale acquaintances, or more succinctly, acquaintances, herein) for a searcher.

Directory server component 125 may receive a request to contact an out-of-touch acquaintance (act 401). The searcher making the request may or may not have previously registered with directory server component 125. The request may be made through, for example, a form presented to the searcher via a web page.

In response to the request, directory service component 125 may gather information relating to the acquaintance from the requesting searcher (act 402). The searcher may provide directory service component 125 with, for example, a single piece of information relating to the acquaintance (e.g., a phone number or email address), or multiples pieces of information. In one implementation, directory service component 125 may allow the searcher to enter as much information about the subscriber as the searcher desires.

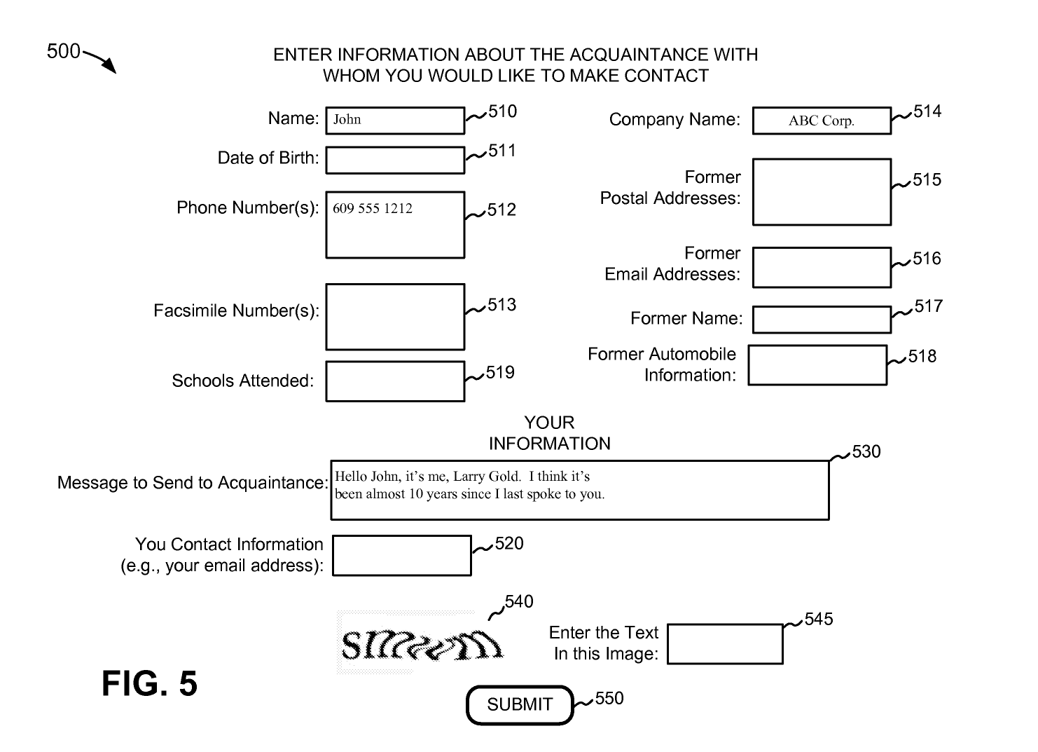

FIG. 5 is a diagram illustrating an exemplary interface 500 that directory service component 125 may provide to a searcher making a request to contact an acquaintance. Interface 500 may provide a number of possible fields 510-519 that the requesting searcher may complete. In one implementation, the searcher may complete as many or as few fields (at least one) as possible. As shown in FIG. 5, fields 510-519 may include, but are not limited to, a name field 510, a date of birth field 511, a phone number(s) field 512, a facsimile number(s) field 513, a company name field 514, a postal address (e.g., city of residence) field 515, an email address field 516, a former name field 517, a former automobile field 518, and a former school field 519. It can be appreciated that additional fields for receiving other types of information may also be used. Alternatively, instead of providing a number of structured fields for the searcher to fill in, directory service component 125 may provide a single unstructured entry box (similar to a conventional search query box used by search engines) in which the searcher may enter information about the subscriber in any convenient order.

In the example of FIG. 5, the searcher has entered information in name field 510, phone number field 512, and company name field 514. The information entered into these fields may be incomplete or out-of-date. For example, the entered name (John) is incomplete, the phone number (609 555 1212) may be a number that is no longer valid for John, and the employer (ABC Corporation) may be a previous employer for John.

Referring back to FIG. 4, if the searcher is not registered with directory service component 125 or has not previously provided contact information to directory service component 125, directory service component 125 may also gather contact information from the searcher (act 403). Interface 500, for example, may include a contact information field 520 through which the searcher may enter a current email address (or possibly another type of contact information) when the searcher has not previously registered with directory service component 125.

Directory service component 125 may allow the searcher to send a message to the subscriber (act 404). As shown in FIG. 5, for example, directory service component 125 may provide a message box 530 through which the searcher may enter a message that is to be delivered to the subscriber.

In some implementations, directory service component 125 may also verify that the searcher is a human and not an automated system that is filling out interface 500 (act 405). For example, a distorted image 540 may be displayed and the searcher may be requested to enter the characters in distorted image 540 into a field 545. Image 540 may be distorted in a way that makes it difficult for optical character recognition systems to determine the characters in the image. Such human verification techniques are generally known and will not be described further herein.

The searcher may submit the information in interface 500 to directory service component 125 by, for example, selecting a graphical button such as a “submit” button 550. With this action, the searcher initiates the request with directory service component 125 to look-up the out-of-date subscriber. Information from storage mechanism 126 may not be disclosed to the searcher. Accordingly, privacy of the subscribers that previously registered with directory service component 125 may be maintained.

Directory service component 125 may match the information submitted by the searcher to the information in storage mechanism 126 (act 406). If the information submitted by the searcher is a single term, such as a single phone number, address, etc., the matching may be a simple comparison to determine if the single piece of information matches another like piece of information in storage mechanism 126. If the information submitted by the searcher includes a number of terms, such as the exemplary information submitted in interface 500, directory service component 125 may attempt to match the terms to each of the registered subscriber profiles stored in storage mechanism 126. For instance, in the example of FIG. 5, there may be many registered subscribers with a name “John,” but there are not likely to be many registered subscribers with the name John that also have a phone number and a company name match. Further, if John Smith, when registering as a subscriber, did not include company “ABC Corporation” or phone number “609 555 1212,” i.e., if he included only one of the two values it is still possible for directory server component 125 to identify John Smith as the intended subscriber.

If one or more matches are determined in act 406, directory service component 125 may inform the searcher that there was a potential match(es) and that the potential matches are being contacted (acts 407 and 408). Directory service component 125 may attempt to contact the subscriber (act 410), by, for example, sending a message to the subscriber address that was previously registered in the preferred method of contact (see FIG. 3, field 325). The message may include a message from the searcher (e.g., the message entered in field 530) and may also include the contact information of the searcher, such as the email address that was entered in email address field 520. On the other hand, if directory service component 125 determines that there is no likely match in storage mechanism 126, directory service component 125 may inform the searcher that the acquaintance they are trying to contact is not known (acts 407 and 409).

The subscriber has control of whether the subscriber wishes to respond to the searcher attempting to contact the subscriber. The subscriber may ignore the message if the subscriber does not recognize the searcher or does not wish to be contacted. However, if the subscriber wishes to communicate with the searcher, the subscriber can contact the searcher by responding to the message.

In some implementations, instead of the searcher providing preferred contact information to the subscriber, a subscriber that chooses to communicate with the searcher may do so using directory service component 125 as a proxy. For example, the subscriber may fill-out an online form provided by directory service component 125, which may forward the response to the requesting searcher. The requesting subscriber and the searcher can continue to communicate through directory service component 125 in this manner until they decide to provide their personal information to one another.

### CONCLUSION

A directory service was described that allows searchers to contact out-of-touch acquaintances or other people being sought. The directory service allows subscribers to be registered for contact without exposing their personal information to contacting searchers.

The foregoing description of exemplary embodiments of the invention provides illustration and description, but is not intended to be exhaustive or to limit the invention to the precise form disclosed. Modifications and variations are possible in light of the above teachings or may be acquired from practice of the invention.

Moreover, while a series of acts have been described with regard to FIG. 4, the order of the acts may be varied in other implementations consistent with the invention. Moreover, non-dependent acts may be implemented in parallel.

It will also be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “components” or “models” that perform one or more functions. These elements may be implemented as hardware, such as an application specific integrated circuit or a field programmable gate array, software, or a combination of hardware and software.

No element, act, or instruction used in the description of the invention should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed:

1. A method comprising:
storing directory information that includes out-of-date contact data obtained from subscribers to a directory service;
receiving a request from a searcher to contact a possible subscriber;
comparing, in response to the request, information associated with the request to the directory information; and
transmitting, when the comparing indicates that the directory information includes the subscriber, a message to the subscriber informing the subscriber of the request to contact the subscriber.

2. The method of claim 1, wherein storing the directory information includes:
providing a form to subscribers that requests the out-of-date contact data.

3. The method of claim 1, wherein the directory information includes one or more of former phone numbers, facsimile numbers, or email addresses.

4. The method of claim 3, wherein a single subscriber is associated with multiple former phone numbers, facsimile numbers, or email addresses.

5. The method of claim 1, wherein receiving the request to contact the subscriber includes receiving a message to send to the subscriber.

6. The method of claim 1, wherein receiving the request to contact the subscriber includes receiving contact information that is sent to the subscriber in the message.

7. The method of claim 1, wherein comparing the information associated with the request to the directory information includes:
receiving a plurality of contact information fields with the request; and
matching the plurality of contact information fields to the directory information to locate one or more potential matching subscribers.

8. The method of claim 1, wherein the information associated with the request includes one or more values that define out-of-date contact information for the subscriber.

9. The method of claim 1, wherein the directory information includes, for each subscriber, current contact information of the subscriber and at least one of a phone number field, a facsimile field, a company name field, a postal address field, an email address field, a former name field, an automobile information field, or a school attended field.

10. A device comprising:
means for storing directory information that includes out-of-date contact data obtained from subscribers;
means for receiving a request to contact a subscriber;
means for comparing information associated with the request to the directory information; and
means for transmitting, when the comparing means indicates that the directory information includes the subscriber, a message to the subscriber informing the subscriber of the request to contact the subscriber.

11. The device of claim 10, wherein the directory information includes one or more of former phone numbers, facsimile numbers, or email addresses.

12. The device of claim 10, further comprising:
means for requesting the subscribers to enter out-of-date contact information.

13. A method comprising:
receiving out-of-date contact information about an acquaintance;
matching the out-of-date contact information to a storage mechanism that includes a plurality of fields configured to store, for each of a plurality of subscribers, out-of-date contact data; and
transmitting a message to one or more of the plurality of subscribers based on the matching of the out-of-date contact information about the acquaintance to the storage mechanism.

14. The method of claim 13, wherein receiving the out-of-date contact information includes a plurality of out-of-date values for a single type of contact information.

15. The method of claim 14, wherein the single type of contact information includes phone numbers, facsimile numbers, or email addresses.

16. The method of claim 13, wherein the out-of-date contact information includes:
at least one of a phone number field, a facsimile field, a company name field, a postal address field, an email address field, a former name field, an automobile information field, or a school attended field.

17. The method of claim 13, further comprising:
receiving a message intended for the subscriber.

18. A system comprising:
a storage mechanism to store directory information defined by a plurality of fields configured to store out-of-date contact data obtained from a plurality of subscribers;
a processor; and
a memory to store instructions that when executed by the processor cause the processor to
receive out-of-date contact information about one of the plurality of subscribers from a searcher interested in making contact with the subscriber;
match the received out-of-date contact information to the directory information stored in the storage mechanism; and
transmit a message to one or more of the plurality of subscribers when the received out-of-date contact information matches the directory information stored in the storage mechanism.

19. The system of claim 18, wherein the out-of-date contact information is obtained from the plurality of subscribers based on a graphical form provided to the plurality of subscribers that encourages the plurality of subscribers to enter out-of-date contact information.

20. The system of claim 18, wherein the directory information includes one or more of former phone numbers, facsimile numbers, or email addresses.

21. The system of claim 20, wherein a single subscriber is associated with multiple former phone numbers, facsimile numbers, or email addresses.

22. The system of claim 18, wherein the memory further includes instructions to cause the processor to receive a message to send to the subscriber.

23. The system of claim 18, wherein the directory information includes current contact information of the plurality of subscribers and at least one of a phone number field, a facsimile field, a company name field, a postal address field, an email address field, a former name field, an automobile information field, or a school attended field.
